(19) United States
(12) Patent Application Publication
(10) Pub. No.: US 2015/0129278 A1
(43) Pub. Date: May 14, 2015

(54) ROUND CABLE

(71) Applicant: DONGGUAN XUNTAO ELECTRONIC CO., LTD., Dongguan City (CN)

(72) Inventor: HUA-BING LI, Dongguan City (CN)

(21) Appl. No.: 14/490,663

(22) Filed: Sep. 18, 2014

(30) Foreign Application Priority Data
Nov. 8, 2013 (CN) 201320705131.0
Dec. 5, 2013 (CN) 201320794437.8

(51) Int. Cl. H01B 7/08; H01B 7/00; H01B 7/02

(52) U.S. Cl. CPC H01B 7/0892; H01B 7/02; H01B 7/0009; H01B 7/0861; H01B 7/0838
USPC 174/107

(57) ABSTRACT

A round cable includes a first flat cable, a shielding layer enclosing on the first flat cable, an insulative outer jacket wrapped on the shielding layer, and an axis extending along a length direction of the round cable. The first flat cable is wound around the axis in a spiral mode for omitting a process of sorting inner wires before welding to a connector.

### BACKGROUND OF THE INVENTION

1. Field of the Invention

The present invention relates to a round cable, and more particularly, to a round cable having a flat cable therein.

2. Description of Related Art

Round cables (coaxial cables et al.) are widely used in various electronic devices as having smaller profiles, but before a round cable soldering with an electrical connector, a lot of manpower are required to place inner conductors of the round cable in order, thus it is such a waste of time and manpower, and may lead to lower efficiency of welding, moreover increase cost of manufacturing.

Hence, a round cable with an improved composition to omit procedure is desired.

### BRIEF SUMMARY OF THE INVENTION

The present invention provides a round cable including a first flat cable, a shielding layer enclosing on the first flat cable, an insulative outer jacket wrapped on the shielding layer, and an axis extending along a length direction of the round cable. The first flat cable is wound around the axis in a spiral mode for omitting a process of sorting inner wires before welding to a connector.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of a round cable in accordance with a first embodiment of the present invention;

FIG. 2 is a cross-section view of the round cable shown in FIG. 1;

FIG. 3 is a cross-section view of a first flat cable of the round cable shown in FIG. 1 while spread on a plane;

FIG. 4 is a cross-section view of a first flat cable of a round cable in accordance with a second embodiment of the present invention; and

FIG. 5 is a perspective view of the round cable in accordance with the second embodiment of the present invention.

### DETAILED DESCRIPTION OF THE PREFERRED EMBODIMENT

Reference will now be made to the drawing figures to describe the embodiments of the present invention in detail. In the following description, the same drawing reference numerals are used for the same elements in different drawings.

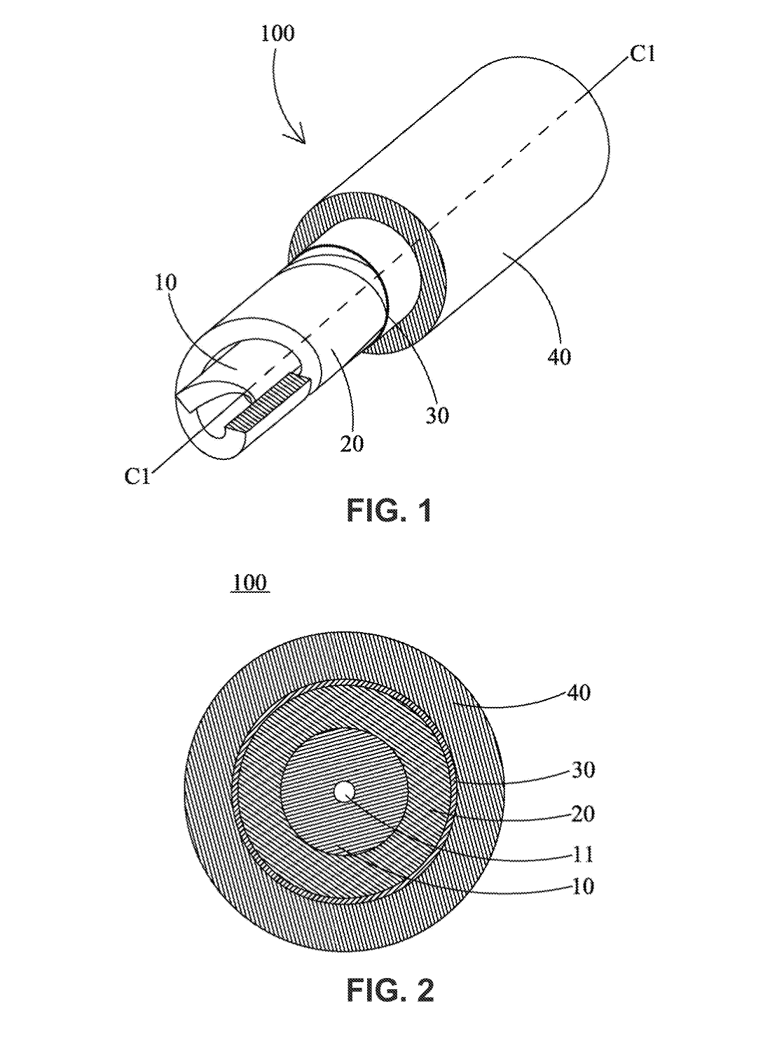

Referring to FIGS. 1 to 2, the present invention discloses a round cable 100 having a circular configuration. According to the first illustrated embodiment of the present invention, the round cable 100 includes a first flat cable 10, a second flat cable 20, a shielding layer 30 and an insulative outer jacket 40.

Each of the first and second flat cable 10, 20 comprises a plurality of inner wires (not shown) separated from each other in a left-to-right direction, and each inner wire may be a grounding wire, a signal wire or a power wire. The round cable 100 has an axis C1 extending along a length direction thereof, and the first flat cable 10 is wound around the axis C1 in a spiral mode. The first flat cable 10 has a central hole 11 in the middle of a cross-section view thereof, and the central hole 11 is also extending along the length direction, the axis C1 is located in the central hole 11. The second flat cable 20 is next to and wound around the first flat cable 10 in the manner of spiraling. The shielding layer 30 is made of an aluminum foil or a copper foil, and enclosing on the second flat cable 20, the insulative outer jacket 40 is wrapping on the shielding layer 30.

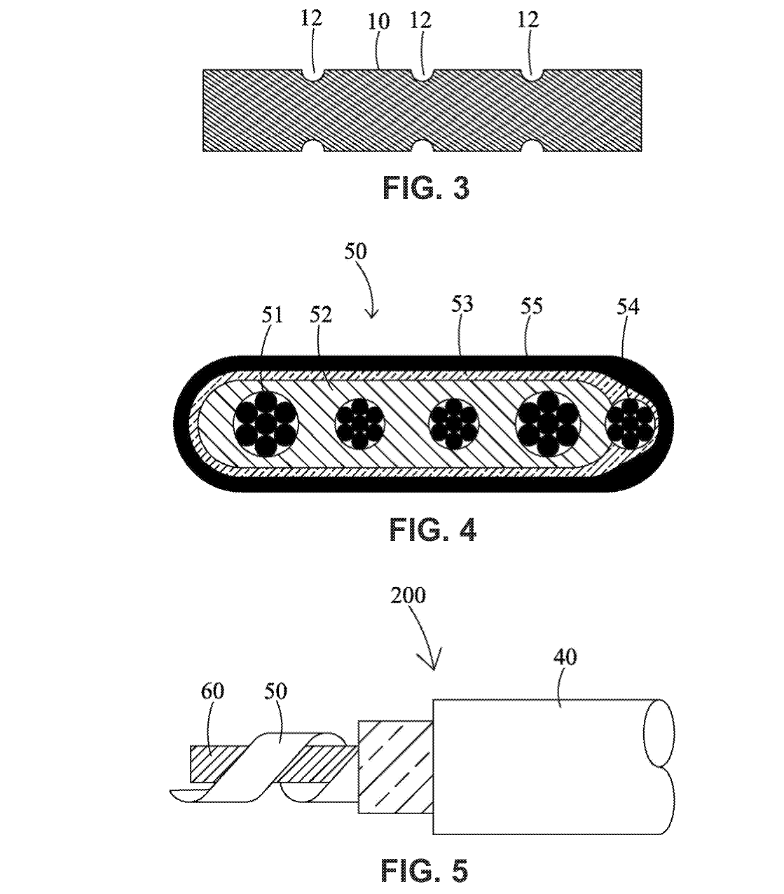

Referring to FIG. 3, the first flat cable 10 has a plurality of cutouts 12 on both sides thereof, and the cutouts 12 on a same side are arranged in a length direction, the cutouts 12 communicate with an exterior along a transverse direction, that is to say, one cutout 12 on one side and the corresponding cutout 12 on another side are back to back. As the cutouts 12 are defined, the first flat cable 10 will have better flexibility, therefore it's easy for the first flat cable 10 winding and the manufacturing difficulty of the round cable 100 can be reduced. In the first embodiment of the invention, the cutouts 12 on a same side are spaced apart from each other, and each cutout 12 is of arc-shaped. The second flat cable 20 also can have a plurality of cutouts (not shown) similar to the first flat cable 10.

Due to the fact that the round cable 100 is provided with the first and second flat cable 10, 20 wound around the axis C1 in a spiral mode, the round cable 100 can have a thinner profile and occupy less space. Moreover, the process of sorting inner wires of the round cable 100 can be omitted before the round cable 100 is welded to a connector, and welding efficiency of the round cable 100 is improved greatly, and production cost is reduced.

Referring to FIGS. 4-5, according to the second embodiment of the present invention, a round cable 200 is a USB (universal serial bus) cable, and formed by a first flat cable 50 wound around a central filled body 60 in the manner of spiraling. The central filled body 60 extends along an axis direction of the round cable 200, and can be accommodated in the central hole 11 of the round cable 100 in the first embodiment of the current invention. The round cable 200 can also achieve the effect of the round cable 100 in the first embodiment. Furthermore, as the central filled body 60 is provided in the round cable 200, the round cable 200 can have a little voidage and approach a circular appearance, a swing life of the round cable 200 can be prolonged and the insulative outer jacket 40 can be extruded conveniently.

The central filled body 60 can be made from cotton thread, plastic material, nylon yarn, or Kevlar et al. according to usage requirements. The first flat cable 50 includes a plurality of signal wires 51 spaced apart from each other in the left-to-right direction, an insulator 52 enclosing on every signal wire 51 to make each signal wire 51 independent, an inner shielding layer 53 disposed on the insulator 52, a grounding wire 54 arranged between the inner shielding layer 53 and the insulator 52, and a conductive plastic layer 55 enwrapped on the inner shielding layer 53. Each of the signal wires 51 and the grounding wire 54 is formed by a plurality of metallic conductors twisted with each other. Additionally, the grounding wire 54 is located on a lateral side of the signal wires 51, and separated from the neighboring signal wire 51. The inner shielding layer 53 is made of an aluminum foil or a copper foil.

In alternative embodiments of the invention, each of the round cables 100, 200 can be constituted by three or more flat cables according to usage and requirements. The shielding layer 30 can be a composition of an aluminum foil mixed with a braiding layer or a copper foil mixed with a braiding layer.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. A round cable, comprising:
a first flat cable;
a shielding layer enclosing on the first flat cable;
an insulative outer jacket wrapped on the shielding layer; and
an axis extending along a length direction of the round cable; wherein
the first flat cable is wound around the axis in a spiral mode.

2. The round cable as claimed in claim 1, wherein a central hole is defined in the middle of a cross-section view of the first flat cable, and the central hole extends along the length direction, the axis is located in the central hole.

3. The round cable as claimed in claim 2, wherein a central filled body is accommodated in the central hole and extends along the length direction, the first flat cable is wrapped on the central filled body.

4. The round cable as claimed in claim 1, further comprising a second flat cable, wherein the second flat cable is next to and wound around the first flat cable in the manner of spiraling.

5. The round cable as claimed in claim 4, wherein the shielding layer is made of an aluminum foil or a copper foil, and sandwiched between the second flat cable and the insulative outer jacket.

6. The round cable as claimed in claim 4, wherein the first flat cable has a plurality of cutouts on both sides thereof, and the cutouts on a same side are separated from each other along a length direction, the cutouts communicate with an exterior along a transverse direction.

7. The round cable as claimed in claim 6, wherein the first flat cable includes a plurality of inner wires separated from each other in a left-to-right direction for transmitting signal, and each inner wire can be a grounding wire, or a signal wire, or a power wire.

8. The round cable as claimed in claim 4, wherein the second flat cable defines a plurality of cutouts on at least one side thereof, and the cutouts are spaced apart from each other.

9. The round cable as claimed in claim 1, wherein the shielding layer can be a composition of an aluminum foil mixed with a braiding layer or a copper foil mixed with a braiding layer.

10. The round cable as claimed in claim 1, wherein the first flat cable includes a plurality of signal wires spaced apart from each other in a left-to-right direction, an insulator enclosing on every signal wire to make each signal wire independent, an inner shielding layer disposed on the insulator, a grounding wire arranged between the inner shielding layer and the insulator, and a conductive plastic layer enwrapped on the inner shielding layer.

11. The round cable as claimed in claim 10, wherein the grounding wire is located on a lateral side of the signal wires, and separated from the neighboring signal wire.

12. A round cable comprising:
a central filled body extending along an axis direction of the round cable;
a first flat cable wrapping on the central filled body; and
an insulative outer jacket being extruded and enclosing on the first flat cable; wherein
the first flat cable is wound around the central filled body in the manner of spiraling.

13. The round cable as claimed in claim 12, further comprising a second flat cable, wherein the second flat cable is enclosing on the first flat cable.

14. The round cable as claimed in claim 12, wherein the round cable is a USB (universal serial bus) cable.

15. The round cable as claimed in claim 14, wherein the central filled body can be made from cotton thread, or plastic material, or nylon yarn, or Kevlar according to usage requirements.

16. The round cable as claimed in claim 15, wherein the first flat cable includes a plurality of signal wires spaced apart from each other in a left-to-right direction, an insulator enclosing on every signal wire to make each signal wire independent, an inner shielding layer disposed on the insulator, a grounding wire arranged between the inner shielding layer and the insulator, and a conductive plastic layer enwrapped on the inner shielding layer.

17. The round cable as claimed in claim 16, wherein each of the signal wires and the grounding wire is formed by a plurality of metallic conductors twisted with each other, and the grounding wire is located on a lateral side of the signal wires, and separated from the neighboring signal wire.

18. A round cable comprising:
an inner filled body and an outer segment coaxially radially sandwiching a middle segment therebewteen;
the outer segment being of an insulative layer;
the middle segment being of at least one flat cable for signal transmission; and
the middle segment being wound around the inner filled body in the manner of spiraling.

19. The round cable as claimed in claim 18, wherein the inner filled body can be made from cotton thread, or plastic material, or nylon yarn, or Kevlar according to usage requirements.

20. The round cable as claimed in claim 18, wherein the flat cable includes a plurality of signal wires spaced apart from each other in a left-to-right direction, an insulator enclosing on every signal wire to make each signal wire independent, an inner shielding layer disposed on the insulator, a grounding wire arranged between the inner shielding layer and the insulator, and a conductive plastic layer enwrapped on the inner shielding layer.
